(19) United States
(12) Patent Application Publication
(10) Pub. No.: US 2018/0060426 A1
(43) Pub. Date: Mar. 1, 2018

(54) SYSTEMS AND METHODS FOR ISSUE MANAGEMENT

(71) Applicant: Robert Francis Gluck, San Marino, CA (US)

(72) Inventor: Robert Francis Gluck, San Marino, CA (US)

(21) Appl. No.: 15/691,548

(22) Filed: Aug. 30, 2017

Related U.S. Application Data
(60) Provisional application No. 62/381,250, filed on Aug. 30, 2016.

(51) Int. Cl. G06F 17/30; G06N 5/04

(52) U.S. Cl. CPC G06F 17/30707; G06Q 10/0635; G06F 17/30619; G06N 5/04

(57) ABSTRACT

A system for providing a multi-technology visual environment for management of issues. A Topic Model is trained via a text corpus for each issue via Topic Model Trainer, also known as the Topic Modeler. Then, incoming discourse texts (such as tweets) are classified to issues organizations care about and are thus relevant, or classified as irrelevant via a Classification Module. Finally, the resulting list of relevant discourse surrounding the issues is scored via a Scoring Module. The modules are configured accordingly. A topic training module configured to allow an user to specify a text corpus representing the discourse surrounding an issue. A topic classification module configured to analyze the data to remove non-material information and classify the text discourse data based on topic. A scoring module configured to assign numerical scores to the classified discourse text based on the issue it is about and the type of entity that created the discourse text for an identified period of time. The modules are further configured to index processing of a collection of data objects and capable of computing a reduced vector space for a collection of data objects using a vector retrieval method that exploits dependencies and semantic similarity between words.

This application claims the benefit of and priority from U.S. Provisional Application No. 62/381,250, REPUTATIONAL ISSUE ANALYSIS UNIT, filed on Aug. 30, 2016, which is fully incorporated herein by reference.

### FIELD OF INVENTION

The invention generally relates to an issue management system comprising of systems and methods for analyzing the world of digital information, a program for analyzing and a method of issue scoring and presentation. More particularly, the instant disclosure relates to systems and methods for tracking issues of relevance to general business world by analyzing change with time in volume of discourse about the issues by using three sequential processes. First, a Topic Model is trained via a text corpus for each issue via Topic Model Trainer, also known as the Topic Modeler. Then, incoming discourse texts (such as tweets) are classified to issues organizations care about and are thus relevant, or classified as irrelevant via a Classification Module. Finally, the resulting list of relevant discourse surrounding the issues is scored via a Scoring Module. Each of these steps is executed at a different frequency using a computer readable medium and statistical programming models.

### BACKGROUND

The world is connected in one digital thread. Numerous technologies and programs are available by which anyone from any part of the world can discuss topics of interests and social issues with impact on businesses on the other side of the world. There are available technologies that can compile all the various text discourses generated via mediums like Twitter and other social media and facilitate bulk analysis of the text. Information generated from this text analysis is important to corporations for marketing, risk analysis, strategy and other business purposes. Furthermore, by understanding such issues enterprises can align their messages of corporate responsibility with such issues and manage the risk around not responding, or how to respond, to public discussion of a social issue.

However, such technologies are limited to serving up the bulk data and usually facilitate searching via keyword and mention tracking. Upon identifying relevant discourse text, analysis typically relies on frequency metrics alone, or sentiment analysis. Accordingly, a need exists for a single, comprehensive technological solution providing both systems and methods to allow identification of discourse about an issue in a more robust way, using natural language processing via Latent Semantic Indexing (LSI) than keyword tracking alone. Such a system can better handle synonymy (multiple words with the same or nearly the same meaning) and polysemy (a word with multiple meanings) would allow issues to be tracked more accurately. In addition, such a system and method can identify relevant text if it contains semantically similar terms as the underlying topic of the discourse is about the issue, but it does not contain keywords identified a priori, and thus allow for more comprehensive measurement of the volume of discourse about an issue. Finally, in addition to the benefits mentioned above, a system is needed to score and benchmark issues so a business knows what requires their attention and management.

### SUMMARY

The presently described apparatus and method overcome the disadvantages of the prior art by providing a novel system and method for issue management that seamlessly integrates a computer implemented system and method of issue management.

An embodiment of the present invention provides a system that follow social media activities (such as “tweets” from Twitter) of a curated set of accounts and classify the text discourses to issues organizations care about. For each piece of text discourse generated by a tracked account (“Actors”) the text is either classified as belonging to 1-3 analyst-identified issue(s) or classified as irrelevant and not used in further scoring or analysis. The system has data processing services that will provide the shared data ingestion and text processing layer platform to the issue management system.

In the context of this invention, first there is the origin of a discourse text by an actor. The discourse text is a public text chunk or document which expresses the discussion around an Issue. This includes, but not limited to a tweet (Twitter), post (Facebook), comment (Reddit), petition (Change.org) and other similar posts. The Issue, includes, but not limited to, a social issue, controversy, or targeted change campaign that the current user of the invention is tracking.

Accordingly, the instant disclosure is directed to systems and methods for managing issues related to topics of interests to organization. The invention is based upon software based modules which can run either on the same computing devices or on different computing devices connected via a network. The modular system coordinates, communicates and performs various functions by using modules such as the Topic Training Module also called a Topic Modeler, a Topic Classification Module also called a Classification Module and a Scoring Module.

In one embodiment of this invention, a system consistent with the systems and methods of the instant disclosure may receive information on the current issues of interests to certain organizations. That information could be a text chunk, discourse surrounding or document which expresses the public discussion around an issue. This can be a tweet (Twitter), post (Facebook), comment (Reddit), petition (Change.org) or other similar information. The system may populate a Topic Model Training Module with received information, transform this information into potential training text which is selected by an analyst if appropriate for training the model.

In one embodiment of this invention, a system consistent with the systems and methods of the instant disclosure will classify via the topics of interest in the Classification via Topic Module.

In one embodiment of this invention, a system consistent with the systems and methods of the instant disclosure will score the topics in the Scoring Module.

In one embodiment of this invention, a system consistent with the systems and methods of the instant disclosure will output the result of the Classification and Scoring Module to an user or analyst via a graphical user interface.

### BRIEF DESCRIPTION OF THE DRAWINGS

The following disclosure as a whole may be best understood by reference to the provided detailed description when read in conjunction with the accompanying drawings, drawing descriptions, abstract, background, field of the disclosure, and associated headings. Identical reference numerals, when found on different figures, identify the same elements or functionally equivalent elements. The elements listed in the abstract are not referenced but nevertheless refer by association to the elements of the detailed description and associated disclosure.

FIG. 1 is an exemplary flow diagram of the overall hardware architecture wherein a system and method in accordance with the present invention can be implemented;

FIG. 2 is a functional block diagram depicting the system and method of managing issues with an embodiment of the claimed invention;

FIG. 3 is a functional block diagram depicting the process overview with an embodiment of the claimed invention;

FIG. 4 is a functional block diagram depicting further details of the steps of processing for Topic Model Trainer with an embodiment of the claimed invention;

FIG. 5 is a functional block diagram depicting the steps of processing for Classification and Scoring Module with an embodiment of the claimed invention;

FIG. 6 is a screenshot of an analyst or user front-end interface utilizing the issue management system.

### DETAILED DESCRIPTION

The present disclosure is not limited to the particular details of the systems and methods depicted and described herein, and other modifications and applications may be contemplated. Further changes may be made in the system or methods without departing from the true spirit and scope of the disclosure herein involved. It is intended, therefore, that the subject matter in this disclosure should be interpreted as illustrative, not in a limiting sense.

For purposes of contrasting various embodiments with the prior art, certain aspects and advantages of these embodiments are described where appropriate herein. Of course, it is to be understood that not necessarily all such aspects or advantages may be achieved in accordance with any particular embodiment. Modifications and variations can be made by one skilled in the art without departing from the sprit and scope of the invention. Moreover, any one or more features of any embodiment may be combined with any one or more other features of any other embodiment, without departing from the scope of the invention.

Disclosed herein is a system and method consistent that seamlessly permit an entity, using a computing platform (or computer), to train, classify and score issues that organizations care about. By using a single interface, a user is able to utilize software platforms produced by multiple vendors that are not directly compatible with one another.

The system is configured to perform several discrete tasks best understood as three sequential steps processed by software platforms. First, the discourse text surrounding the issue generated is captured via an Application Programming Interface (API). The captured data is then transferred to a database, the Data Lake, connected with the Topic Modeler which interfaces with the Model Training User Interface. Then, incoming discourse texts (tweets) are classified to issues generally clients care about, or classified as irrelevant. Finally, the resulting list of relevant discourse is scored. Each of these steps is executed at a different frequency. Each of these functions is discussed separately herein.

In an embodiment, a Topic Model is trained via a text corpus for each relevant issues generated based on the text discourse surrounding an issue. The Topic Model training can be conducted on demand depending on analyst execution. The training starts with Topic relevant keyword query, followed by feed of the discourse data, which is further added into a combination of raw text corpus insert and human selection of relevant discourse text. The final product is a trained Topic Model, in other words, the Topic Model Trainer Module.

A topic model is a statistical representation of the discourse surrounding an issue, represented as a term frequency-inverse document matrix with a single document for each issue, created from the analyst-selected discourse training text, such that each document is generated for each issue. The term frequency-inverse document frequency matrix is then transformed into a latent space with a lower dimensionality using singular value decomposition. This method commonly known as Latent Semantic Indexing is implemented within the Issue Management systems.

Latent Semantic Indexing (LSI) is an advanced information retrieval technology that is a variant of the vector retrieval methods that exploit dependencies between data objects such as words surrounding issues and terms of interest. For example, one such dependency is a semantic similarity between data objects. Latent Semantic Indexing works on the assumption that there exists some underlying or latent structure in the pattern of word usage across data objects, and that this structure can be discovered and measured statistically. One benefit of this approach is that, once a suitable reduced vector space is computed for a collection of data objects, a query can retrieve data objects similar in meaning or concepts even though the query and document have no exact matching terms. The present invention leverages such index processing technology for the plurality of text corpus for each relevant issues generated based on the text discourse surrounding an issue and finding the underlying or latent structure in the pattern of word usage so that this underlying structure can be discovered and measured statistically.

In an embodiment, the discourse text (e.g. a tweet) is ingested from a controlled list of Actors monitored by the system. The discourse text is then indexed leveraging Latent Semantic Indexing against the topic model which contains all issues tracked by the Issue Management System. Once it is properly indexed and classified the Scoring Module using an algorithm produces a similarity score, which is further registered against each topic. For any similarity scores above 0.75, the discourse text is classified as belonging to at most the top three issues ranked by similarity score. In this way it is either classified as belonging to one to three issues via the topic modeler, or is deemed irrelevant. This results in a database of issue relevant discourse texts.

In an embodiment, the systems and methods disclosed provides for a client setup on an individual instance. An instance provides web service capabilities on cloud based servers. Each client instance is isolated, and client specific configurations or data cannot move from one client instance to another client's instance. However, much of the data that is processed and displayed within the system comes from processing performed by the data services, which encompasses the Topic Model Training and Topic Classification of the data ingestions and processing layer of the computer.

In an embodiment, the core Topic Model for training and classification as used by the data services is performed by a Latent Semantic Indexing (LSI) instead of Boolean queries in order to better accommodate words with multiple meanings (polysemy) and multiple words with similar meanings (synonymy) within the Topic Model Trainer.

In an embodiment, Topic models are trained for each issue. This involves an analyst building a training corpus which reflects the way that issue is discussed in the medium (e.g. Twitter). The statistical distribution of words used to discuss that topic is the core of the topic model.

In an embodiment, using a Twitter Keyword Stream, the method requires the user to construct a keyword query, which then submits it to the search Application Programming Interface and returns tweets based on the query. In such cases, up to 5000 tweets are gathered under the topic on the “model trainer” tab within the Topic Model Trainer Module. From the keyword query, the analyst may select “exemplar tweets” which reflect the public discourse about an issue. When the analyst clicks “train topic”, the system is programmed to train the Topic Modeler for a particular topic. A statistical model of the topic based on the exemplar tweets is built within the Topic Model Trainer Module.

In an embodiment, an exemplary method of Raw Text upload is used instead of a keyword tweet stream. Raw text upload allows the analyst to find tweets off-platform or use any text source (e.g. a Wikipedia page) for the development of a training corpus within the Topic Model Trainer Module or the Topic Modeler. In such embodiment, the end result is the same as the keyword stream—a statistical model of the topic based on the text that was entered.

The systems and methods disclosed in the present invention permits some topic models to be trained in real time—for example, if there is a situation that a keyword stream is not suitable for developing a training corpus, the system is designed to favor uploading the raw text.

In an embodiment, the issue-management has an analyst front-end interface provided by the Application Server that allows an analyst to view scoring and specific pieces of discourse text across plurality of issues. In addition, the front-end interface also allows the configuration of the Actors list that is provided as an input into the Scoring Module.

In an embodiment, each client instance has a unique Uniform Resource Locator such as for retail industries, food processors and other industries. The systems and methods of the present invention will allow the creation of new instance of login credentials for each new client before setup and use can begin. The application gives the options to provide login credentials and access must be granted to both data services and the issue management system. Logins with Usernames are provisioned for each instance and Usernames will be set for each client. The system will have provision to set passwords by the users of the system.

In an embodiment, a text corpus that reflects the public discussion about an issue is gathered by an analyst in order to train a classification model. This may be done two ways—one via gathering of text and insertion into the system as raw text.

In an embodiment, a stream is created which collects data, including, but not limited to, tweets via a keyword search. Data matching the keyword query are then evaluated and depending on their relevance to the issues, the data is used to create a training corpus.

In an embodiment, an analyst may add text to a training corpus at any time. The systems and methods of the present invention also implements preprocessing of the training corpus data to remove stop words and stemming. For example, Latent Semantic Index used with the current systems and methods technique uses text retrieval methods that exploit dependencies or semantic similarity between the words surrounding a discourse.

In an embodiment, the systems and methods utilizes a “bag of words” approach—where the individual sources of the words and their orders are not tracked in the term frequency-inverse document frequency matrix.

In one embodiment of the present invention, the Classification Module, part of the Data Services uses Latent Semantic Indexing as a search—the incoming tweet from an Actor is a search query, and classify it to the topic which it best matches, or none at all. The Classification of incoming discourse is a continuous execution and approximately three discrete units of discourse texts are classified per minute.

In an embodiment, once a Topic Modeler is trained for n topics, incoming data, including, but not limited to tweet, can be classified to one topic or issue. The classification is processed in a Classification Module by calculating a similarity score, which is the distance between the vector space (topic or issue) model and the vector space model of the incoming data. If the incoming data receives similarity scores less than a predetermined number [for example, less than 0.75] for all topics, then it remains in the data lake but is not classified to any topics. The incoming tweet text is further augmented if it includes a hyperlink. In such case, the page metadata such as title, description, and keywords are ingested from the HTML meta tags and used as additional text for comparing the discourse to modeled topics.

In an embodiment, the systems and methods of the present invention for each topic, the Scoring Module calculates a score at the start of each new day and for the previous day (and any days before that scoring has been calculated).

The systems and methods of the present invention provides a Scoring Module to calculate the score by an actor type (activist, influencer, corporate, policy maker, industry) and combined scores are calculated for each topic, dividing the actors of interest into activist, influencers, and corporations. Scores are calculated for each category, as well as the composite scores for each day based on the trailing 7 days scores and are normalized from 0.0-10.0 scores by using scoring engine algorithms.

In an embodiment, the Scoring Module in the Issue Management System is configured to produce the following types of scores: (1) a Compound Score of even weighted average of the Activist, Corporate, Industry, Policy Maker, and Influencer scores; (2) an Outreach Score calculated for each piece of discourse text, it is the sum of discrete numeric scale score of retweets, favorites, user follower count, and Actor verification status; (3) a Corporate Score calculated for each issue, using tweets from Actors of type Corporate, this score is a custom weighting of average outreach scores, number of unique mentions of the corporation, number of total mentions of the corporation, the total number of tweets, and total number of unique Actors; (4) an Influencer Score calculated for each issue, using tweets from Actors of the given type, this score is a custom weighting of average outreach scores, the total number of tweets, and total number of unique Actors; (5) a Change Score for calculated as a change in two-week average score changes over a five-week moving window; and (6) a Relevance Score where each issue is assigned an integer relevance score ranging from 1 to 5 by an analyst.

The systems and methods of the present invention includes from a plurality of text discourses surrounding an issue, an issue relating to a subject indicated by the discourses; and means which calculates the statistical relevance of such issues for each point of time when there is a voluntary action expressed by a text discourse representing the same issue and classifies and provides a score for the issue.

The systems and methods of the present invention uses a program recording medium in a computer-implemented system storing a program for issue management and analysis and enables a computer to execute the processes of a ‘topic model’ trained via a text corpus for each issue; incoming discourse texts (tweets) are classified as relevant or irrelevant; and finally the resulting list of relevant discourse is scored.

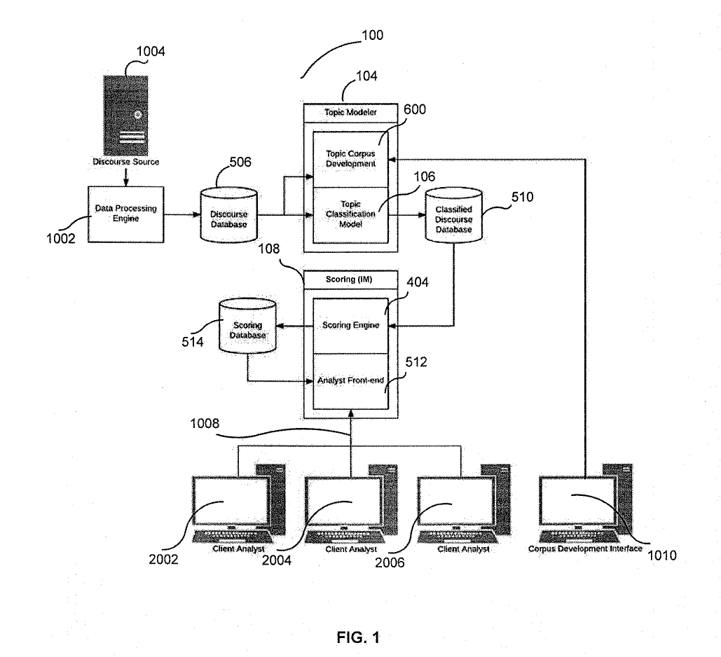

FIG. 1 illustrates the hardware configuration 100 wherein a system and method in accordance with the present invention can be implemented on one or more computing devices. The system connected through an internal network includes a data processing engine 1002 communicatively connected to the source of discourse text 1004. The data processing engine 1002 is further communicatively connected to the discourse database 506, the topic modeler 104, including the topic classification 106 and Scoring Module 108 and an application server hosting the analyst front-end 512. The topic modeler 104 is further communicatively connected internally to the Corpus Development Interface 1010. Each of these are suitable for connecting to one another and to a plurality of computing devices and each may comprise one or more networks such as a local area network (LAN), a wide area network (WAN) such as the Internet, telephone networks including telephone networks with dedicated communication links and/or wireless links, and wireless networks. Various hardware devices (including but not limited to routers, modems, switches, etc.) may separate the elements of the hardware configuration 100, so long as the various elements are communicatively coupled together as shown in FIG. 1.

The system hardware configuration 100 comprises one or more computing devices configured to implement application server hosting the analyst front-end 512, and a data processing engine 1002. While each of these elements is shown as being implemented on a separate computing device, in an embodiment, a single computing device may implement the application server hosting the analyst front-end 512, and the data processing engine 1002. Alternatively, in another embodiment any of these elements may be implemented on multiple computing devices.

Client Analysts devices 2002, 2004 and 2006 communicatively coupled with the internal network, comprises a display device and an input device as described herein and renders a graphical user interface (“GUI”) that is used to convey information to and receive information from a user. The GUI includes any interface capable of being displayed on a display device including, but not limited to, a web page, a display panel in an executable program running locally on the client devices 2002, 2004 and 2006 or any other interface capable of being displayed to the user. In the illustrative embodiment shown in FIG. 1, in accordance with the present invention, the GUI is displayed by the client devices 2002, 2004 and 2006 using a browser or other viewing software such as, but not limited to, Microsoft Internet Explorer, Google Chrome, Apple Safari, or Mozilla Firefox, or any other commercially available viewing software. In an embodiment, the GUI is generated using a combination of commercially available hypertext markup language (“HTML”), cascading style sheets (“CSS”), JavaScript, and other similar standards.

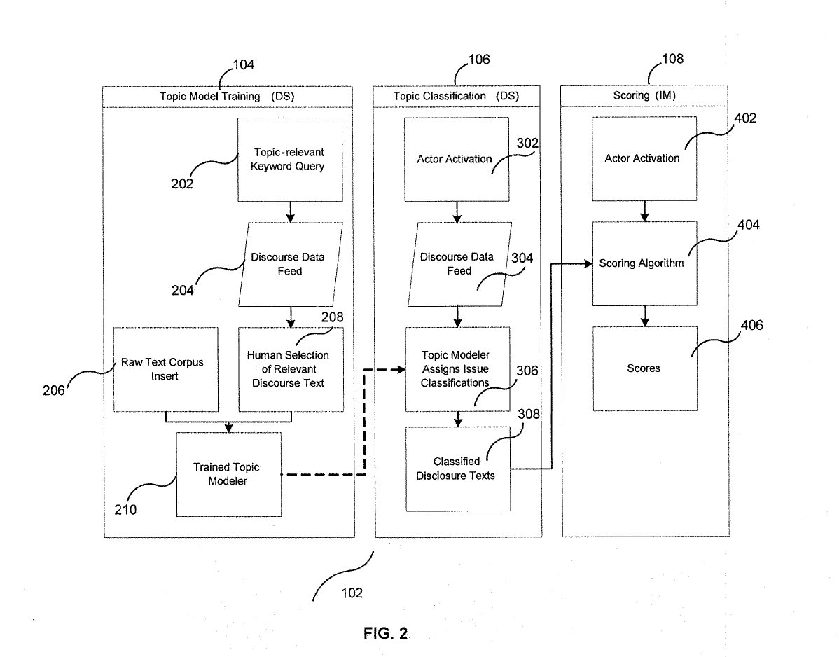

FIG. 2 illustrates the core architecture of the system 102 in accordance with an embodiment of the present invention. As shown, the system comprises the topic trainer module 104 also known as the Topic Modeler, the classification module 106 and the scoring module 108 communicatively connected with the application server 1004. The topic trainer module 104 has the trained topic modeler 210 which communicates with the classification module 106 and which serves as an intermediary between the topic trainer module 104 and the scoring module 108. In an embodiment, the topic trainer module 104 interprets requests and commands and relays them to the appropriate module.

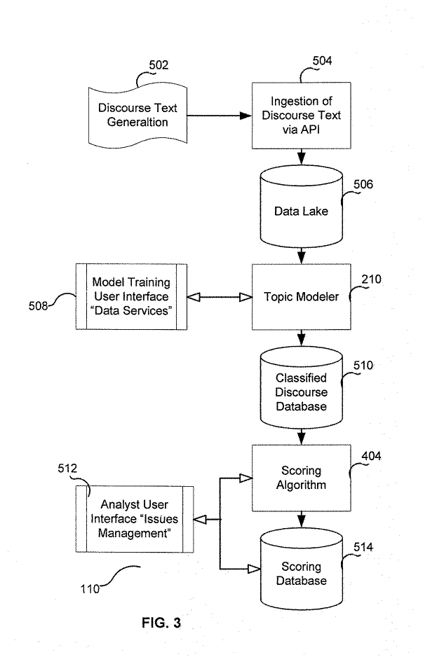

FIG. 3 illustrates the architecture of the process 110 for issue management starting from discourse text generation 502 getting ingested by the data processing engine 1002 via the Application Programming Interface 504. The discourse is then processed within the database 506 connected with the Topic Modeler 210. The discourse is next classified in a classified discourse database 510 and ultimately scored using the scoring algorithm 404 and added to the scoring database 514. The analyst or user can use the GUI interface through the client devices 2002, 2004 and 2006 for interfacing with the issue management and reviewing the scoring and relevance as further illustrated in the present disclosure.

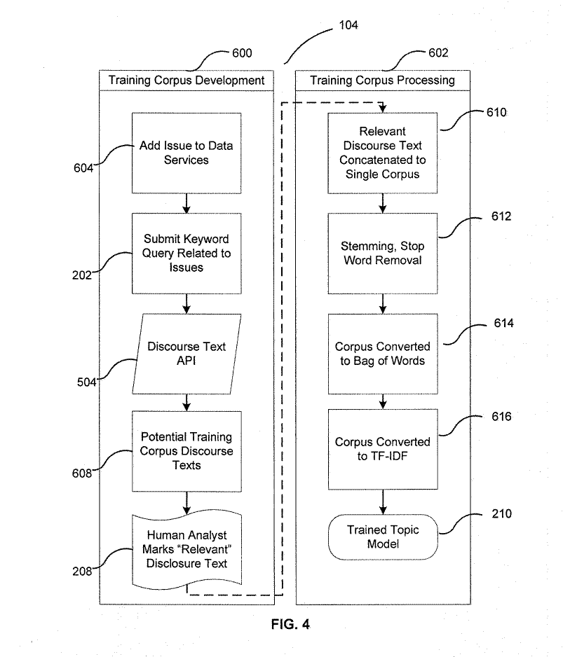

FIG. 4 illustrates the architecture of topic trainer module 104 comprising the training corpus development module 600 and the training corpus processing engine 602, together working in concert to train the Topic Modeler. A topic relevant keyword query 202 generates the discourse data feed 204. Further raw text corpus insert 206 along with human selection of relevant discourse text 208 is ingested into the trained topic modeler 210. The key part of developing the topic model trainer 104 is the corpus development 600. An analyst or a user can add issue 604 to the data processing engine 1002 as well as submit a keyword query related to issues 202, ingested by the data processing engine 1002 via the Discourse Text Application Programming Interface 504, creating a training corpus discourse texts 608. The training corpus discourse texts 608 is further marked by an analyst or a user as relevant 208 and then the relevant discourse text is concatenated to a single corpus 610. The training corpus processor 602 then processes the information concatenated to a single corpus 610 by utilizing stemming 612 to generate a corpus converted to a bag of words 614. The corpus is converted to a term frequency-inverse document matrix 616 with a single document for each issue, such that each document is generated for each issue. The final output is a trained topic modeler 210 which is communicatively connected with the Classification module 106 and the scoring module 108.

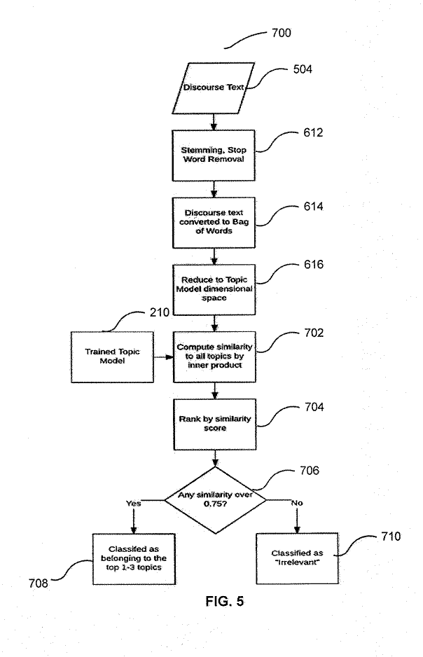

FIG. 5 illustrates the functional architecture of how the systems and methods for the trained topic modeler 210 work in concert with the Discourse Text Application Programming Interface 504 to compute similarity to all topics 702 by using Latent Semantic Indexing processing and ranking by similarity score 704. If the similarity score is above a certain predetermined number 706, the discourse text is classified as belonging to at most the top three issues ranked by similarity score 708. In this way it is either classified as belonging to one to three issues via the topic modeler, or is deemed irrelevant 710.

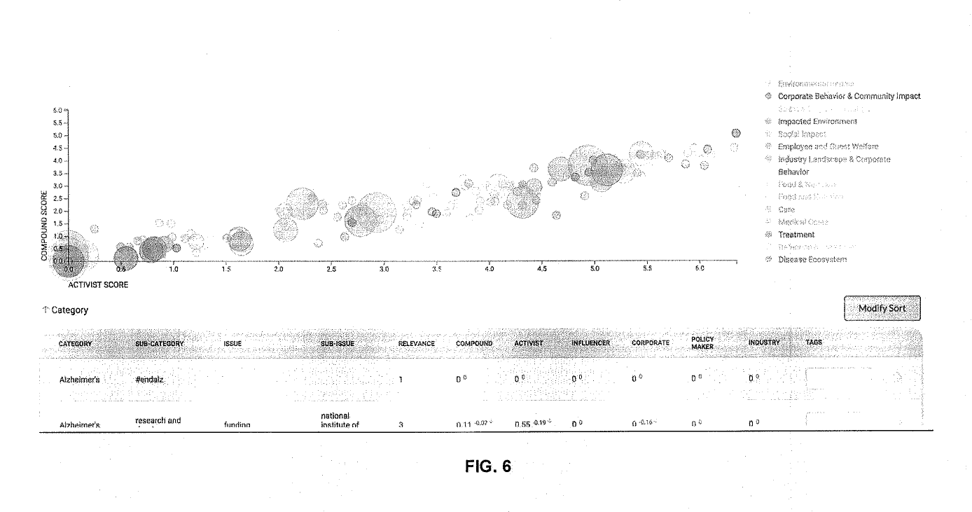

FIG. 6 is a screen-shot of a graphical user interface (GUI) for the analyst-front end interface 512 where the analyst can review the issues and the relevancy score for the issues in a graph format.

In one embodiment consistent with FIG. 1, the discourse text surrounding the issue generated is captured via an Application Programming Interface (API). The captured data is then transferred to a database, the Data Lake connected with the Top Modeler which interfaces with the Model Training User Interface. Then, incoming discourse texts (tweets) are classified to issues generally clients care about, or classified as irrelevant. Finally, the resulting list of relevant discourse is scored. Each of these steps is executed at a different frequency and may be implemented, for example, by a general purpose computer or data processor selectively activated or reconfigured by a stored computer program, or may be a specially constructed computing platform for carrying out the features and operations disclosed herein.

Computing Platform for the above embodiment may be implemented or provided with a wide variety of components or systems as known in the art including, for example, one or more of the following: central processing unit, co-processor, memory, registers, and other data processing devices and subsystems.

Network and communication between the various modules may include, alone or in any suitable combination, a telephony-based network, a local area network (LAN), a wide area network (WAN), a dedicated intranet, the Internet or World Wide Web, a wireless network, a bus, or a backplane. Further, any suitable combination of wired and/or wireless components and systems may be incorporated into the network. Moreover, the network may be embodied as bi-directional links or as unidirectional links.

The Systems and methods of the present invention may be embodied in various forms, including, for example, a data processor, such as the computer that also includes a database. Moreover, the above-noted features and other aspects and principles of the instant disclosure may be implemented in various environments. Such environments and related applications may be specially constructed for performing the various processes and operations of the instant disclosure, or they may include a general-purpose computer or computing platform selectively activated or reconfigured by code to provide the necessary functionality.

The processes disclosed herein are not inherently related to any particular computer or other apparatus, and may be implemented by a suitable combination of hardware, software, and/or firmware. For example, various general-purpose machines may be used with programs written in accordance with the instant teachings, or it may be more convenient to construct a specialized apparatus or system to perform the required methods and techniques.

Apparatus, systems and methods consistent with the instant disclosure also include computer-readable media (or memory) that include program instructions or code for performing various processing device-implemented operations based on the methods and processes described herein. The media and program instructions may be those specially designed and constructed for the purposes of the instant disclosure, or they may be of the kind well known and available to those having skill in the computer software arts. Examples of program instructions include, for example, machine code, such as produced by a compiler, and files containing a high-level code that can be executed by the computer using an interpreter.

Furthermore, although the embodiments above refer to processing information related to discourses surrounding an issue, classification and scoring of the issue, systems and methods consistent with the instant disclosure may process information related to other types of data. Moreover, although reference is made herein to using the scoring to assess and rank an issue, in its broadest sense systems and methods consistent with the instant disclosure may provide a score for any type of data, including, but not limited to, financial other market data.

While particular preferred embodiments have been shown and described, it is to be understood that the foregoing description is exemplary and explanatory only and is not restrictive of the instant disclosure. Those skilled in the art will appreciate that changes and additions may be made without departing from the instant teachings. For example, the teachings of the instant disclosure may be directed to various combinations and sub-combinations of the disclosed features and/or combinations and sub-combinations of several further features described herein. It is therefore contemplated that any and all modifications, variations or equivalents of the above-described teachings fall within the scope of the basic underlying principles disclosed above and claimed herein.

What is claimed is:

1. A system for providing a multi-technology visual environment for management of issues, the system comprising:
an internal network comprising a data processing engine, and an application server communicatively coupled together; a client device communicatively coupled to said engine and said application server;
wherein said application server is configured to render a graphical user interface;
wherein the said system is configured to implement:
a topic training module configured to allow an user to specify a text corpus representing the discourse surrounding an issue;
a topic classification module configured to analyze the data to remove non-material information and classify the text discourse data based on topic; and
a scoring module configured to assign numerical scores to the classified discourse text based on the issue it is about and the type of entity that created the discourse text for an identified period of time;
wherein said topic training module, said topic classification module and said scoring module is further configured to index processing of a collection of data objects; and
capable of computing a reduced vector space for a collection of data objects using a vector retrieval method that exploits dependencies and semantic similarity between words in order to find a latent structure in the pattern of word usage in said collection of data objects;
and capable of retrieving data objects similar in meaning or concepts even though the query and document have no exact matching terms.

2. A computer implemented method for providing a multi-technology visual environment for management of issues, the method comprising:
training a topic training module with a text corpus representing the discourse surrounding an issue;
classifying the text discourse data based on topic; and
scoring said classified discourse text by assigning numerical scores based on the issue it is about and the type of entity that created said discourse text for an identified period of time.

3. The system of claim 1, wherein said topic training module is further configured to implement the steps of:
collecting discourse text surrounding an issue;
capturing the text via an application programming interface within the system;
transferring the captured text to a database;
wherein the database is networked with a Topic Modeler;
providing an interface to a Topic Training Module;
wherein the incoming discourse texts are classified and scored based on a pre-determined criteria.

4. The system of claim 1, wherein
the Topic training Module is trained by using analyst-selected text chosen from a relevant keyword query, followed by input of discourse data surrounding a text for each plurality of issues generated surrounding an issue.

5. The system of claim 1, wherein the user can be an analyst.

6. The system of claim 1, wherein the scoring module can calculate a compound score, outreach score, corporate score, influencer score, change score and relevant score.
